(19) United States
(12) Patent Application Publication
(10) Pub. No.: US 2010/0191160 A1
(43) Pub. Date: Jul. 29, 2010

(54) MASSAGER

(76) Inventors: Eyal Avramovich, Hod Hasharon (IL); Yacov Gurievsky, New York, NY (US)

Correspondence Address: MERCHANT & GOULD PC, P.O. BOX 2903, MINNEAPOLIS, MN, 55402-0903, US

(21) Appl. No.: 12/692,310

(22) Filed: Jan. 22, 2010

Related U.S. Application Data
(63) Continuation-in-part of application No. PCT/IL2008/001013, filed on Jul. 22, 2008.
(60) Provisional application No. 60/951,239, filed on Jul. 23, 2007.

(51) Int. Cl. A61H 7/00

(52) U.S. Cl. 601/94

(57) ABSTRACT

Massager vehicle for autonomously traveling on the body of a patient, The massager vehicle is massaging the body of the patient, the massager vehicle includes a vehicle chassis, at least one motor, at least three wheels, a roll tilt sensor, a pitch tilt sensor, a boundary sensor and a controller, The at least three wheels are coupled with the chassis, at least one of the wheels is positioned at a first side of the chassis and at least another one of the wheels is positioned at a second side of the chassis, opposite to the first side, the roll tilt sensor determines a roll angle of the massager vehicle, the pitch tilt sensor determines a pitch angle of the massager vehicle, the boundary sensor determines when the massager vehicle is approaching a boundary, beyond which the massager vehicle may not travel, the controller controls the motion of the massager vehicle the controller is coupled with the motor, the roll tilt sensor, the pitch tilt sensor and with the boundary sensor, the controller receives information from the roll tilt sensor, the pitch tilt sensor and from the boundary sensor, the controller instructs the motor to change the direction of travel of the massager vehicle according to the received information.

This application is a Continuation-in-Part of PCT/IL2008/001013, filed 22 Jul. 2008, which claims benefit of U.S. Ser. No. 60/951,239, filed 23 Jul. 2007 and which applications are incorporated herein by reference. To the extent appropriate, a claim of priority is made to each of the above disclosed applications.

### FIELD OF THE DISCLOSED TECHNIQUE

The disclosed technique relates to massager apparatus, in general, and to massager vehicle system for autonomously massaging a patient, in particular.

### BACKGROUND OF THE DISCLOSED TECHNIQUE

Massaging devices are known in the art. Generally, these devices of a couch, chair, or other body support, which produce vibratory, oscillatory, reciprocating, percussing, or rotary movements, or in form of a handheld electrically powered device which the user applies to a desirable part of the body.

U.S. Pat. No. 7,108,669 B2 issued to Huang, and entitled “Massager”, is directed to a device which provides wobbling movements. The device includes a housing, a motor, a kneading assembly, and a rubbing assembly. The kneading assembly includes two kneading plates, a worm gear, two wobbling wheels, two driving gears, and a transmission axle. Each of the wobbling wheels is provided with a sleeve. Each of the kneading plates is mounted on the transmission axle, on an opposite side of the worm gear, between the respective wobbling wheel, and the driving gear. The rubbing assembly includes a bearing, a driven axle, a driven gear, disk, and two rubbing balls. The driven axle is mounted on the bearing. The driven gear and the disk are mounted on the driven axle.

The driven gear meshes with the driving gear. The worm gear is powered by the motor. When the wobbling wheel is rotated by the transmission axle, the sleeve is wobbled relative to the wobbling wheel.

Since the kneading plate is mounted on the sleeve, the kneading is wobbled, when the transmission axle is rotated by the motor.

U.S. Pat. No. 4,505,267 issued to Inada, and entitled “Portable Massaging Device”, is directed to a device which produces see-saw motion. The device includes a casing, a handle, a covering, a pad, an electric motor, two elastic cylinders, a frame, an eccentric cam, a crank member, a plurality of power transmission components, such as shafts, gears, bearings, and pulleys, and a pair of muscle relaxing wheels. The frame is connected to the casing. The casing is made of soft material, such as leather. The pad is connected to the frame by the two elastic cylinders. The eccentric cam is connected to the electric motor and the crank member. A leg portion of the crank member is connected the frame. The muscle relaxing wheels are powered by the electric motor, are located under the covering. The muscle relaxing wheels make contact with an inside surface of the covering. When the electric motor is powered, the eccentric cam rotates, thereby causing the crank member to move up and down. The up and down motion of the crank member is transmitted to the pad, through the two elastic cylinders, thereby producing the see-saw motion. The electric motor rotates the muscle relaxing wheels. The user can place the muscle relaxing wheels around his neck and shoulder, to obtain relaxation.

U.S. Pat. No. 5,843,006 issued to Philips et al., and entitled “Massaging Device”, is directed to a device for massaging the body of a user. The device includes a case, an inner housing, a plurality of brackets, a first pair of fingers, a second pair of fingers, a third pair of fingers, and a fourth pair of fingers, a motor, a drive shaft, a cam disk, a plurality of rollers, a plurality of springs, and a plurality of rubber tips. The brackets are connected to the inner housing. Each of the rollers is connected with the respective one of the pair of fingers. Each of the springs is connected to the respective pair of fingers. Each of the rubber tips is connected to an outer end of the respective finger. The cam disk is connected with the motor, by the drive shaft. Each pair of fingers is pivotally connected between the brackets. Each pair of the rollers makes contact with an inner and outer surface of the cam disk. When the motor rotates the cam disk, the rollers rotate, thereby causing each pair of the fingers to pivotally and transversely reciprocate, so that the outer ends move toward and away from one another. As the fingers reciprocate, the outer ends define a circular arc.

A robot for performing massage by tickling a subject, is disclosed on the following internet web site: http://www.xs4all.nl/˜notnot/tickle/TICKLEspecs.html, as well as in the article “Morphogenetics: generative processes in the work of Driessens & Verstappen”, Mitchell Whitelaw, Digital Creativity, 2003 vol. 14, No. 1, pp. 43-53. The Tickle Robot includes a microcontroller, a dual axis tilt sensor, a couple of geared mini motors, a rechargeable Lithium Polymer battery, an aluminum cover and chassis, a plurality of urethane wheels with ball bearings and a couple of silicone rubber caterpillar tracks. The silicone rubber caterpillar tracks are coupled with the geared mini motors via the urethane wheels. The geared mini motors are further coupled with the rechargeable battery, and with the microcontroller. The microcontroller is further coupled with the dual axis tilt sensor. The microcontroller controls the motion of the tickle robot according to the dual axis tilt sensor tilt indication. When the microcontroller receives tilt indication respective of a possibly unstable situation, the microcontroller can either reverse the tickle robot, or pivot it and change the direction of motion. The microcontroller can perform spontaneous maneuvers when no unstable tilt indication is received from the dual axis tilt sensor.

U.S. Pat. No. 7,153,282 issued to Dudley, and entitled “Finger Massager”, is directed to a hand held massaging device including a top housing, a lower housing, a plurality of curved massaging implements, and an actuating mechanism. The lower housing includes a base with implements openings. The curved implements extend in adjustable aligned opposing rows through the implement openings. Each of the curved implements includes a ball tip such that it can be rotated and locked in the rotated position to alter the massaging action. The actuating mechanism is coupled with the top housing and can move, in a reciprocate manner, each row of implements in a combined normal and parallel unison, relative to the lower housing base. A user moves the massaging device over a portion of a body of a treated user while the motion of the implements closely approximates the finger motion of a human masseur. U.S. Pat. No. 6,679,858 issued to Ray, and entitled “Device to Assist in Relaxation and Relief of the Stress of a Subject”, is directed to a relaxation inducing device. The relaxation device includes a base, a vertical support column, a motor, a sweeping arm, a plurality of contact members and a timer. The support column extends vertically from the base. The height of the vertical support column is adjustable. The motor is rotatably coupled at the upper end of the vertical support column. The motor is further coupled with the timer. The proximal end of the sweeping arm is coupled with the motor such that the support arm is horizontally oriented outward from the motor. The plurality of contact members are coupled with the sweeping arm such that they extend downwards from the sweeping arm. A user lies prone on a bed near the base. By setting the timer, the rotation time of the motor is determined. The sweeping arm rotates back and forth above the back of the user. The contact members make contact with the back of the user (i.e., after proper adjustment of the vertical column height) and move back and forth across the back of the user.

### SUMMARY OF THE PRESENT DISCLOSED TECHNIQUE

It is an object of the disclosed technique to provide a novel method and system for automatically massage a patient, which overcomes the disadvantages of the prior art. In accordance with the disclosed technique, there is thus provided a massager vehicle for autonomously traveling on the body of a patient. The massager vehicle is massaging the body of the patient. The massager vehicle includes a vehicle chassis, at least one motor, at least three wheels, a roll tilt sensor, a pitch tilt sensor, a boundary sensor and a controller. The at least three wheels are coupled with the chassis. At least one of the wheels is positioned at a first side of the chassis and at least another one of the wheels is positioned at a second side of the chassis, opposite to the first side. The roll tilt sensor determines a roll angle of the massager vehicle. The pitch tilt sensor determines a pitch angle of the massager vehicle. The boundary sensor determines when the massager vehicle is approaching a boundary, beyond which the massager vehicle may not travel. The controller controls the motion of the massager vehicle. The controller is coupled with the motor, the roll tilt sensor, the pitch tilt sensor and with the boundary sensor. The controller receives information from the roll tilt sensor, the pitch tilt sensor and from the boundary sensor. The controller instructs the motor to change the direction of travel of the massager vehicle according to the received information.

According to another embodiment of the disclosed technique there is thus provided a massager vehicle for autonomously traveling on the body of a patient. The massager vehicle massages the body of the patient. The massager vehicle includes a vehicle chassis, at least one motor, a plurality of legs, a roll tilt sensor, a pitch tilt sensor, a boundary sensor, and a controller.

Each of the plurality of legs are coupled with the chassis and with the at least one motor. The roll tilt sensor determines a roll angle of the massager vehicle. The pitch tilt sensor determines a pitch angle of the vehicle. The boundary sensor determines when the massager vehicle is approaching a boundary, beyond which the massager vehicle may not travel. The controller controls the motion of the vehicle. The controller is coupled with the motor, the roll tilt sensor, the pitch tilt sensor and with the boundary sensor. The controller receives information from the roll tilt sensor, the pitch tilt sensor and from the boundary sensor. The controller instructs the motor to change the direction of travel of the vehicle according to the received information.

### BRIEF DESCRIPTION OF THE DRAWINGS

The disclosed technique will be understood and appreciated more fully from the following detailed description taken in conjunction with the drawings in which:

FIG. 1A is a schematic illustration of the components of a massager vehicle, constructed and operative in accordance with an embodiment of the disclosed technique;

FIG. 1B is an isometric illustration of the massager vehicle of FIG. 1A from a bottom view perspective;

FIG. 1C is an isometric illustration of the massager vehicle of FIG. 1A from a top view perspective;

FIG. 1D is a schematic illustration of the massager vehicle of FIG. 1A traveling on the back of a patient from a side view perspective;

FIG. 1E is a schematic illustration of the massager vehicle of FIG. 1A traveling on the back of the patient from a top view perspective;

FIG. 2A is a schematic illustration of a massager vehicle, having legs, constructed and operative in accordance with another embodiment of the disclosed technique;

FIG. 2B is a schematic illustration of a front view of the massager vehicle of FIG. 2A;

FIG. 2C is a schematic illustration of the massager vehicle of FIG. 2A, having a different leg configuration;

FIG. 3A is a schematic illustration of a massager vehicle traveling on the body of a patient at a roll inclination, constructed and operative in accordance with a further embodiment of the disclosed technique;

FIG. 3B is a schematic illustration of the massager vehicle of FIG. 3A, traveling on the body of the patient at a pitch inclination;

FIG. 4A is a schematic illustration of a gravity fan tilt sensor, constructed and operative in accordance with another embodiment of the disclosed technique;

FIG. 4B is a schematic illustration of the gravity fan tilt sensor of FIG. 4A in which the light barrier is divided into a plurality of barrier sectors;

FIG. 4C is a schematic illustration of a top view of a groove and ball tilt sensor, constructed and operative in accordance with a further embodiment of the disclosed technique;

FIG. 4D is a schematic illustration of a side view of the groove and ball tilt sensor of FIG. 4C;

FIG. 5 is a schematic illustration of a massager vehicle including a massage generator, constructed and operative in accordance with another embodiment of the disclosed technique;

FIG. 6 is a schematic illustration of a massager vehicle including a boundary sensor, constructed and operative in accordance with a further embodiment of the disclosed technique;

FIG. 7 is a schematic illustration of a massager vehicle including a plurality of massage generators, constructed and operative in accordance with another embodiment of the disclosed technique;

FIG. 8 is a schematic illustration of a massager vehicle, including a massage generator, constructed and operative in accordance with a further embodiment of the disclosed technique;

FIGS. 9A, 9B, 9C, and 9D are schematic illustrations of a massager vehicle, including a plurality of pinching double wheels for climbing the skin and the clothes of the patient, constructed and operative in accordance with another embodiment of the disclosed technique; and

FIG. 10 is a schematic illustration of a method for positioning a vehicle at the center of an interest area, operative in accordance with a further embodiment of the disclosed technique.

### DETAILED DESCRIPTION OF THE EMBODIMENTS

The disclosed technique overcomes the disadvantages of the prior art by providing a massager vehicle, capable of autonomously navigating on the body of a patient. The massager vehicle massages the patient while traveling thereon and employs several massaging features, such as caressing, vibrating, tapping, squeezing, pinching, tickling, shiatsu massage, acupuncture, applying lotions, applying heat or cold, applying electrical currents, applying magnetic fields, applying phototherapy (e.g., infra red frequencies) and the like.

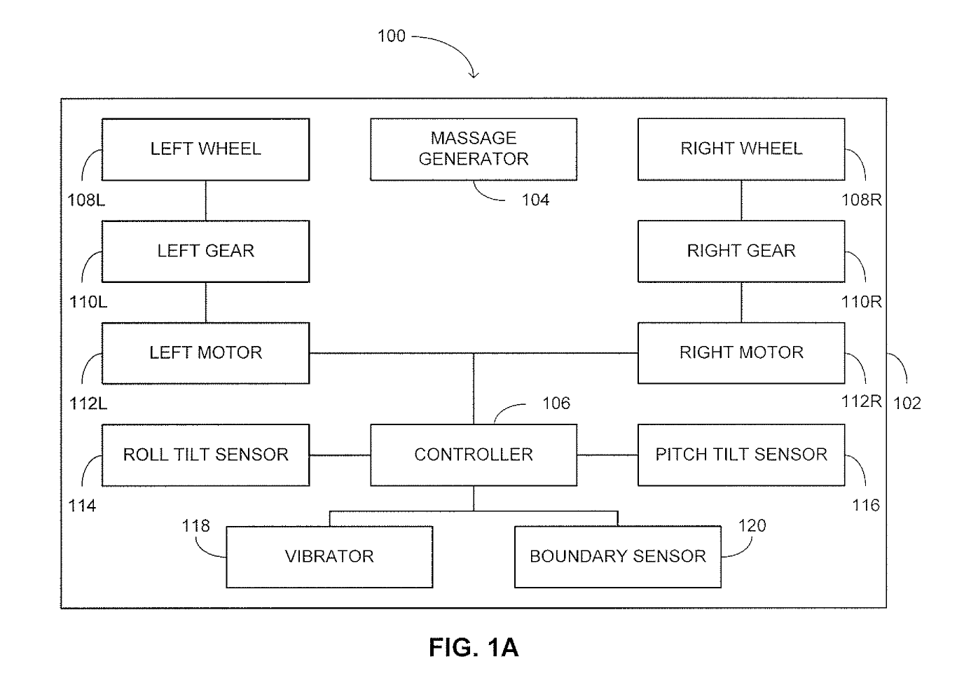

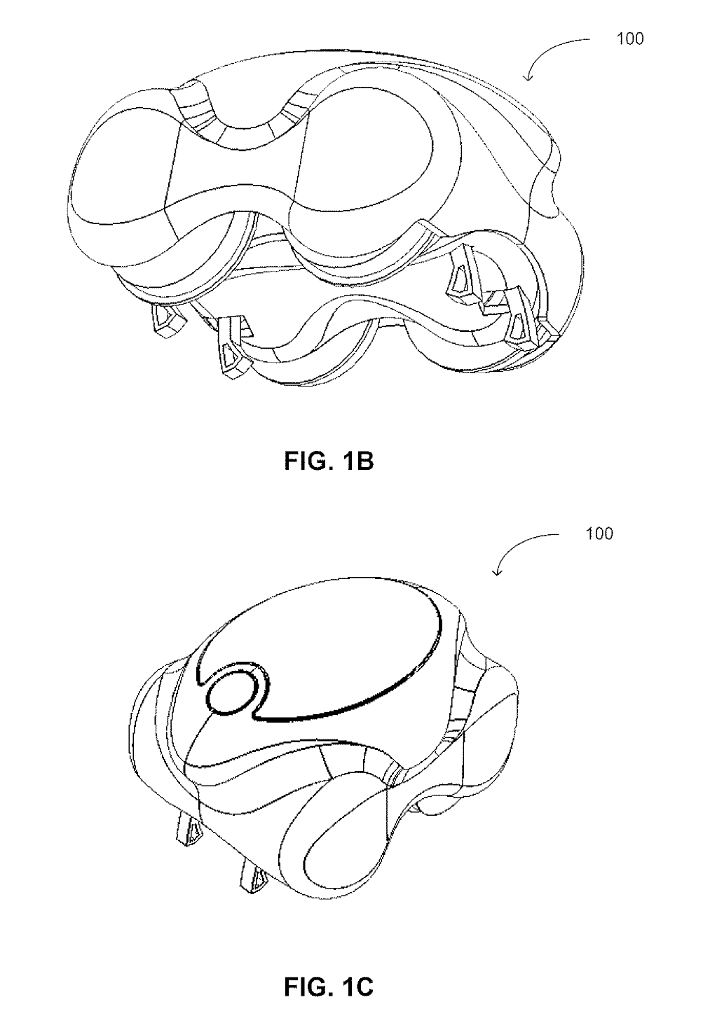

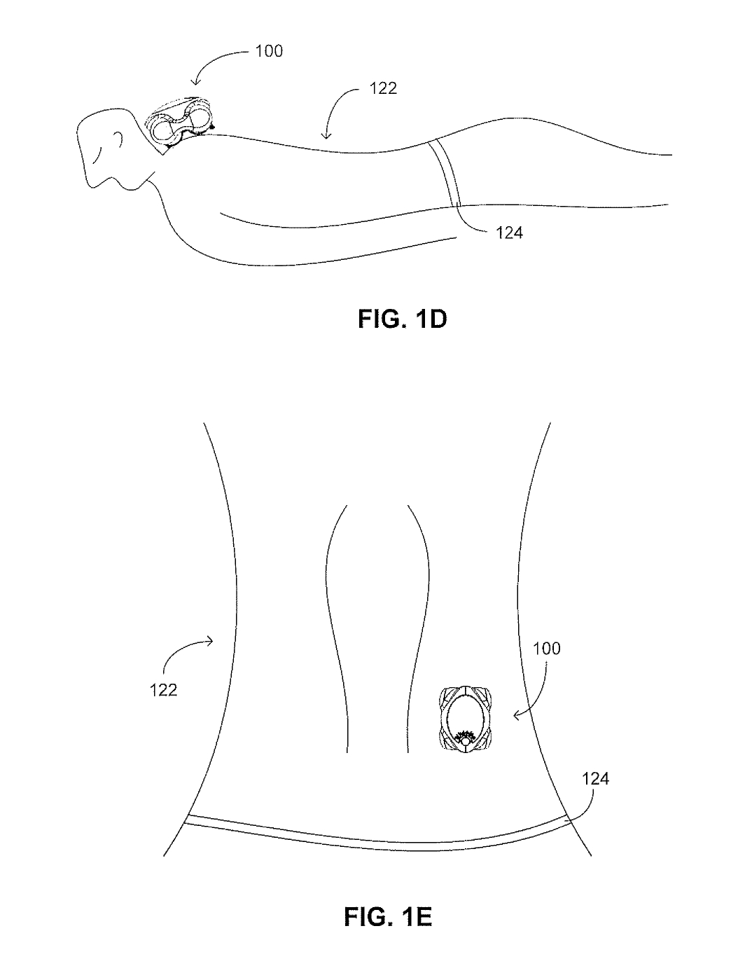

Reference is now made to FIGS. 1A, 1B, 1C, 1D and 1E. FIG. 1A is a schematic illustration of the components of a massager vehicle, generally referenced 100, constructed and operative in accordance with an embodiment of the disclosed technique. FIG. 1B is an isometric illustration of the massager vehicle of FIG. 1A from a bottom view perspective. FIG. 1C is an isometric illustration of the massager vehicle of FIG. 1A from a top view perspective. FIG. 1D, is a schematic illustration of the massager vehicle of FIG. 1A traveling on the back of a patient, generally referenced 122, from a side view perspective. FIG. 1E, is a schematic illustration of the massager vehicle of FIG. 1A traveling on the back of the patient from a top view perspective.

With reference to FIG. 1A, massager vehicle 100 includes a massager vehicle housing 102, at least one right wheel 108R, at least one left wheel 108L, a right transmission gear 110R, a left transmission gear 110L, a right motor 112R, a left motor 112L, a roll tilt sensor 114, a pitch tilt sensor 116, a vibrator 118, a boundary sensor 120, a controller 106, and a massage generator 104. Right transmission gear 110R is coupled between right wheel 108R and right motor 112R. Left transmission gear 110R is coupled between left wheel 108R and left motor 112R. Controller 106 is coupled with right motor 112R, left motor 112L, roll tilt sensor 114, pitch tilt sensor 116, vibrator 118, and with boundary sensor 120. All of right wheel 108R, left wheel 108L, right transmission gear 110R, left transmission gear 110L, right motor 112R, left motor 112L, roll tilt sensor 114, pitch tilt sensor 116, vibrator 118, boundary sensor 120, and controller 106 are encased within housing 102. Massage generator 104 is externally coupled with housing 102 such that massage generator touches the surface, massager vehicle 100 is traveling thereon (i.e., for touching a patient while massager vehicle 100 is traveling thereon).

Massager vehicle 100 is positioned on the body of a patient (e.g., patient 122 of FIG. 1D). Massager vehicle 100 autonomously travels on the body of the patient and massages the patient while traveling thereon. Massager vehicle 100 changes the direction of movement when determining the topography is not safe (e.g., the inclinations are steep, the surface is narrow, and the like).

Massager vehicle 100 includes at least one right wheel 108R, at least one left wheel 108L and a total of at least three wheels for maintaining stability (e.g., two right wheels and a left wheel; two left wheels and a right wheel; two right wheels and two left wheels; a right wheel, a left wheel and a front wheel; and the like). While massager vehicle 100 travels on the body of the patient, right wheels 108R and left wheels 108L apply pressure to the surface of the body of the patient, they travel thereon. It is noted that, massager vehicle 100 can be made from heavy materials in order to increase the pressure applied to the body of the patient. Alternatively, massager vehicle 100 includes a weight in order to increase the pressure applied to the body of the patient.

The texture of the perimeter of right wheels 108R and left wheels 108L (i.e., the portion of the wheels touching the surface, massager vehicle 100 travels thereon) can be smooth, course, jagged, granular, or any other texture as determined by the preference of the patient. The texture of the perimeter of at least a portion of right wheels 108R and left wheels 108L is further determined according to a massaging feature (e.g., the texture of the perimeter of right wheels 108R is determined such that it is appropriate for applying lotion while traveling on the body of the patient).

Right wheels 108R and left wheels 108L are relatively big (i.e., in relation to the total size of massager vehicle 100). Right wheels 108R and left wheels 108L are positioned such that the ground clearance, approach angle and departure angle of massager vehicle 100 are enhanced. Thus, massager vehicle 100 is able to negotiate varied obstacles (e.g., anatomical obstacles such as shoulder blades, and clothing obstacles, such as buttons, zippers, belts and pockets).

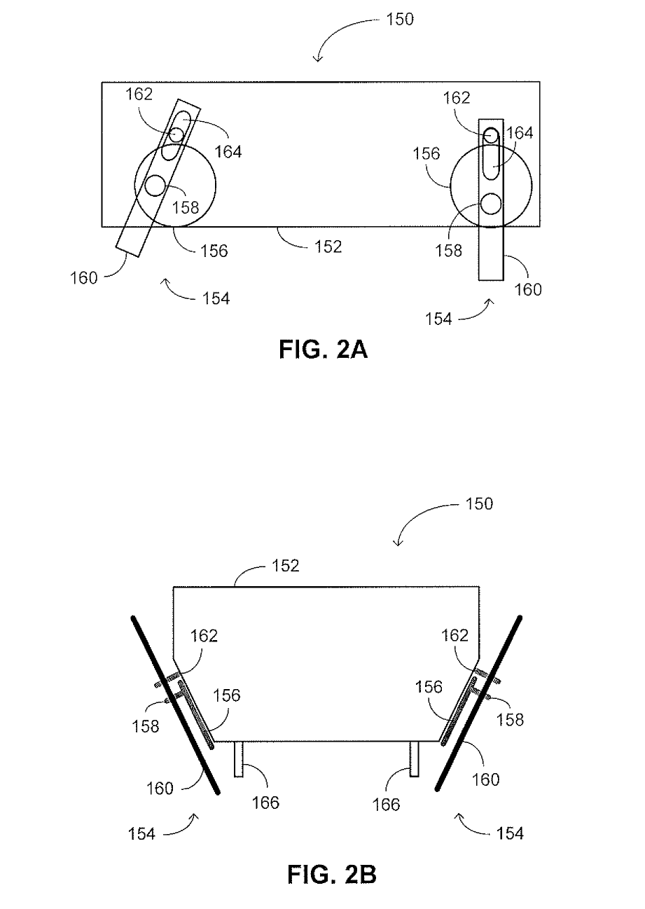

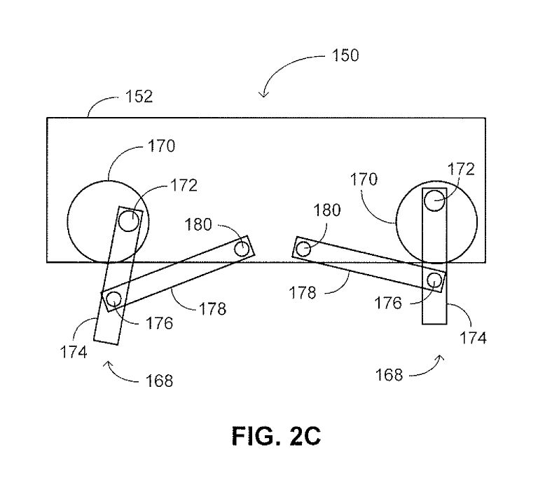

Alternatively, right wheels 108R and left wheels 108L are replaced by a right track and a left track, respectively. The right track is coupled with right transmission gear 110R. The left track is coupled with left transmission gear 110L. The right track and left track can be formed of various materials (e.g., plastic, metal, rubber, and the like) and of various textures (e.g., smooth, granular, coarse, and the like) according to the preferences of the patient. Further alternatively, right wheels 108R and left wheels 108L are replaced by legs, as detailed herein below with reference to FIGS. 2A, 2B and 2C.

Right transmission gear 110R and left transmission gear 110L are directed at providing speed-torque conversion (i.e., speed reduction). By reducing the speed, right transmission gear 110R and left transmission gear 110L increase the power applied by massager vehicle 100 to the body of the patient. Right transmission gear 110R and left transmission gear 110L are quiet transmission gears which silence the noise of right motor 112R and left motor 112L, respectively. One example of a quiet transmission gear is a transmission gear constructed of an elastic material (e.g., rubber). Alternatively, massager vehicle 100 includes no transmission gears and employs other transmission mechanisms such as belts, pulleys, and the like. Further alternatively, massager vehicle 100 includes no transmission mechanisms and the motors are directly coupled with the wheels.

Right motor 112R and left motor 112L can operate at a low Rounds Per Minute (RPM) rate for further silencing massager vehicle 100. Right motor 112R and left motor 112L are engines which generate kinetic movement from a power source. Some examples of motors are electric motors, fuel motors, spring motors, and the like. Right motor 112R operates right wheels 108R via right transmission gear 110R. Left motor 112L operates left wheels 108L via left transmission gear 110L. In this manner, massager vehicle 100 can drive forward, backward, turn sideways and even rotate while remaining in the same position by operating one of right motor 112R and left motor 112L in one direction and the other one in the opposite direction (i.e., similar to a tank). It is noted that, right motor 112R and left motor 112L can each include more than a single motor. Alternatively, both right motor 112R and left motor 112L are replaced by a single motor. In such a case the single motor is coupled with right wheels 108R and with left wheels 108L via a transmission mechanism, such that the single motor can operate each of right wheels 108R and left wheels 108L independently.

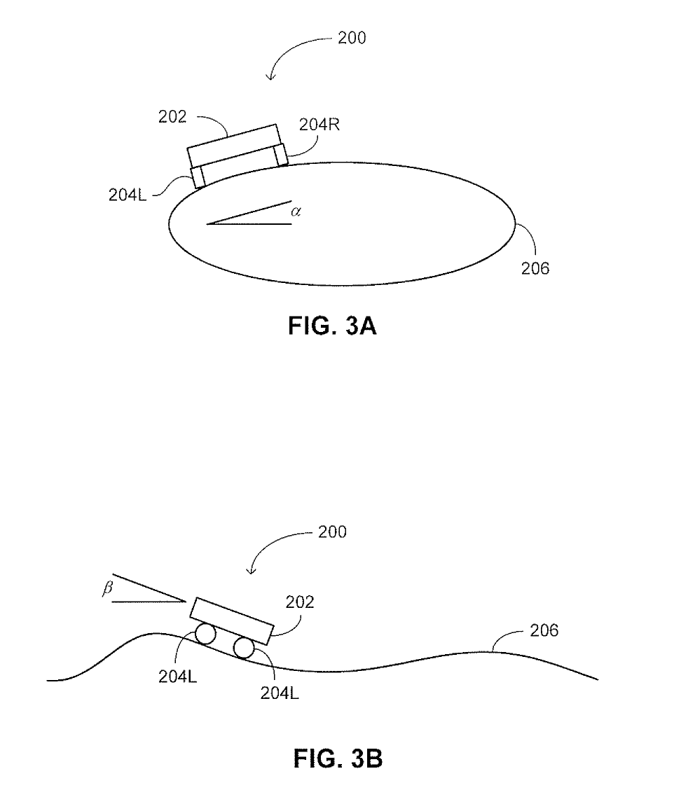

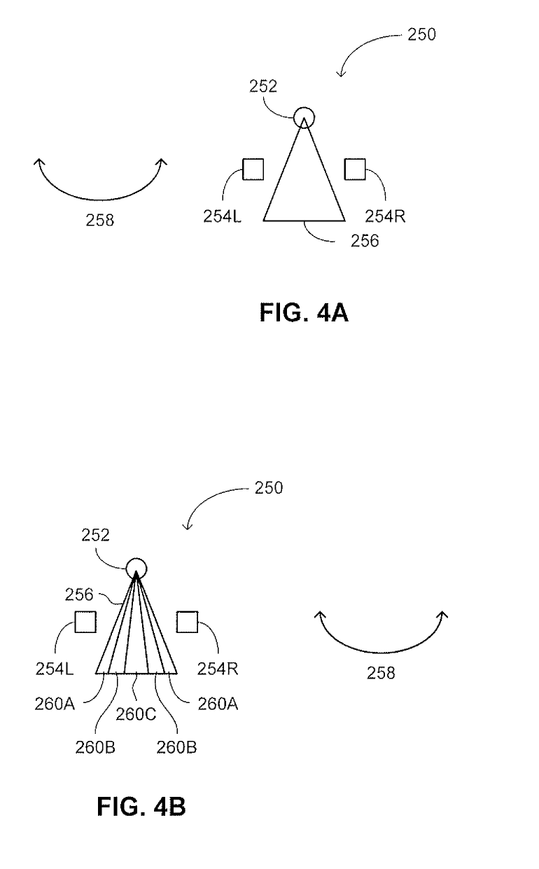

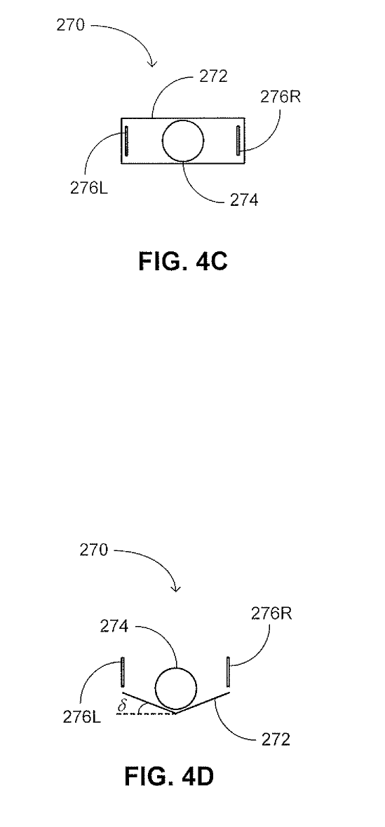

Roll tilt sensor 114 determines whether massager vehicle 100 is at a roll angle (i.e., side inclination) which might be unstable, as detailed further with reference to FIG. 3A. Pitch tilt sensor 116 determines whether massager vehicle 100 is at a pitch angle (i.e., front or back inclination) which might be unstable, as detailed further with reference to FIG. 3B. Some examples of tilt sensors are a gravity fan tilt sensor (as detailed with reference to FIGS. 4A and 4B), liquid capacitive (e.g., Mercury) inclinometer, piezoelectric sensor, electrolytic inclinometer, gas bubble in liquid inclinometer, a groove and ball tilt sensor (as detailed further with reference to FIGS. 4C and 4D), and the like.

Boundary sensor 120 is a sensor for determining whether massager vehicle is approaching a pre-determined boundary, beyond which massager vehicle 100 should not travel for various reasons (e.g., the lower waistline of the patient is a boundary, which is marked by a physical obstacle such as a belt and beyond which massager vehicle 100 is not stable).

Boundary sensor 120 enables massager vehicle 100 to travel upon a large body area (i.e., larger than the area traveled on by depending on roll tilt sensor 114 and pitch tilt sensor 116 alone), as detailed herein below. For example, boundary sensor 120 prevents massager vehicle 100 from reaching the legs (i.e., the legs are unstable area from which massager vehicle 100 can fall of the body of the patient) of the patient and enables massager vehicle 100 to travel all along the back from the neck to the lower buttocks. A massager vehicle depending on tilt sensors can pass the buttocks and travel downwards along one leg (not shown) of the patient. The massager vehicle 100 would travel along the leg until it will fall at the narrow portion of the respective leg, unless the sensitivity of the tilt sensors is increased. Thus, a massager vehicle without a boundary sensor would not approach the lower back of the patient (i.e., because of the increased tilt sensors sensitivity). Boundary sensor 120 enables massager vehicle 100 to travel on the lower back of the patient and the buttocks of the patient by detecting a boundary on the lower end of the buttocks (e.g., a towel wrapped below the waistline of the patient). In this manner the sensitivity of the tilt sensors is limited by the balance of massager vehicle 100 (i.e., the tilt sensors are not calibrated to prevent massager vehicle 100 from climbing the buttocks of the patient).

A first example of boundary sensor 120 is a touch sensor in the form of a small rod, extending toward the surface that massager vehicle 100 is traveling thereon, for sensing a physical obstacle, such as the belt of the patient, and the like. A second example of boundary sensor 120 is an optical sensor for sensing a predetermined boundary, such as a towel covering the pelvis of the patient, a designated marking on the body of the patient, and the like. A third example of boundary sensor 120 is a magnetic sensor sensing a designated marking on the body of the patient. A fourth example of boundary sensor 120 is a processing unit for determining the boundary by calculation (e.g., stopping massager vehicle whenever it travels more than X seconds in one direction). A fifth example of a boundary sensor is detailed further with reference to FIG. 6. A sixth example of boundary sensor 120, is a Radio Detection and Ranging (RADAR) sensor operating at Micro-Wave frequencies. A seventh example of boundary sensor 120, is a Sound Navigation and Ranging (SONAR) sensor.

Vibrator 118 is a vibrating element as known in the art (e.g., eccentric weight). Vibrator 118 vibrates massager vehicle 100 for increasing the stimulation of the patient and the efficiency of the massage. Vibrator 118 is switched on and off according to the preferences of the patient or according to a massaging feature (e.g., vibrator is turned off when applying heat to the skin of the patient). Vibrator 118 is further switched on and off according to the position of massager vehicle 100 for maintaining stability (i.e., when massager vehicle 100 is at a steep inclination, vibrator 118 is switched off to increase the stability of massager vehicle 100).

It is noted that, vibrator 118 is either a directional vibrator or a circular vibrator. A directional vibrator 118 can be installed such that it generates vibrations in any of a plurality of directions, such as vibrating in the forward-backward (i.e., anterior-posterior) direction, sideways (i.e., lateral) direction, and top-bottom (dorsal-ventral) direction. A circular vibrator 118 can be installed such that it generates circular vibrations in the plane of movement of massager vehicle 100 or in a perpendicular plane thereto. In the example set forth in FIG. 1A, vibrator 118 is circular and generates circular vibrations in the plane of movement of massager vehicle 100.

Vibrator 118 might affect each of roll tilt sensor 114, pitch tilt sensor 116 and boundary sensor 120 (i.e., the sensors), and induce false readings there-within. In order to decrease the affect of vibrator 118 on these sensors, each of these sensors is constructed, in terms of shape and materials, such that the resonant frequency of each of these sensors is vastly different that the vibrations frequency of vibrator 118, and is at least not a multiple of the vibrations frequency of vibrator 118, such that the affect of the vibrations on the readings of these sensors are damped over time. In this manner the vibrations of vibrator 118 have a negligible affect on the readings of these sensors.

Controller 106 is a microcontroller (e.g., a microprocessor chip). Controller 106 controls massager vehicle 100. Controller 106 receives information from roll tilt sensor 114 and pitch tilt sensor 116, relating to the roll angle and pitch angle of massager vehicle 100. Controller 106 further receives information from boundary sensor 120. Controller 106 controls right motor 110R and left motor 110L. Alternatively, controller 106 controls right transmission gear 110R and left transmission gear 110L as well as right motor 112R and left motor 112L. Further alternatively, controller 106 controls right transmission gear 110R and left transmission gear 110L instead of controlling right motor 112R and left motor 112L.

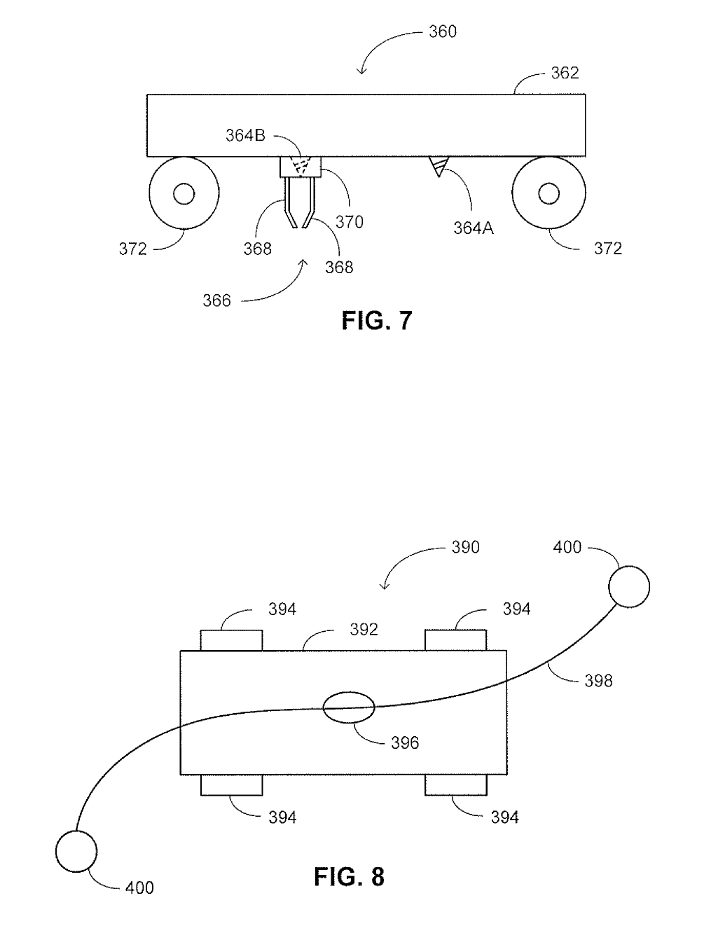

Controller 106 determines when to change the direction of movement of massager vehicle 100 according to the information received from roll sensor 114, pitch sensor 116, and boundary sensor 120, and according to a massaging feature (e.g., controller 106 is turning massager vehicle 100 and drives back and forth in order to increase the stimulation of the patient). Controller 106 further controls vibrator 118. Controller 106 can position massager vehicle 100 at the center of the body of the patient by employing a movement algorithm as detailed further with reference to FIG. 7.

When controller 106 determines that massager vehicle 100 is positioned approximately at the center of the body of the patient, massager vehicle 100 can perform unstable massaging maneuvers.

Unstable massaging maneuvers are massaging maneuvers which might be considered unstable, if massager vehicle 100 were positioned near an edge (e.g., the side—lateral—edge of the back of the patient) of the body of the patient. Unstable massaging maneuvers can include moving back and forth, rotating, taking sharp turns, vibrating, and the like. Unstable massaging maneuvers are directed at increasing the stimulation of the patient.

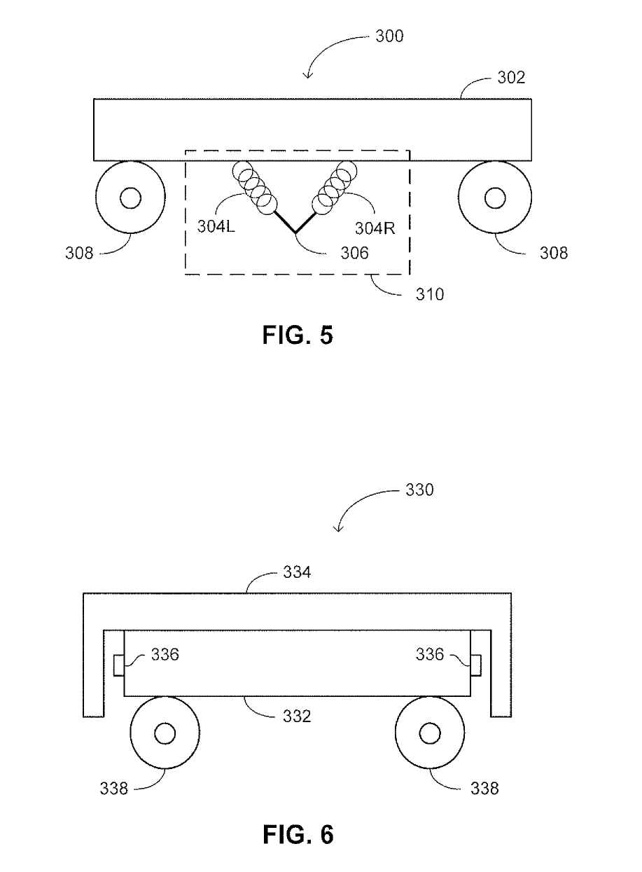

Massage generator 104 is a physical element directed at massaging the patient while massager vehicle travels thereon. Massage generator 104 extends towards the surface, massager vehicle 100 is traveling thereon, and touches the body of the patient. Massage generator can take several forms (e.g., massage generator 310 of FIG. 5). Massage generator 104 can be made of various materials and have various textures according to the preference of the patient (e.g., a smooth metal massage generator, a feather-like massage generator, a course wooden massage generator and the like).

Massage generator 104 can perform a massaging feature, such as caressing the body of the patient, vibrating the body of the patient, tapping on the body of the patient, squeezing the body of the patient, pinching the body of the patient, tickling the patient, shiatsu massage, acupuncture, applying phototherapy, applying heat or cold to the body of the patient, applying electrical current to the body of the patient, applying magnetic field to the body of the patient, applying a liquid to the body of the patient (e.g., lotion or aromatic oil), or a combination thereof, and the like.

Applying aromatic oils can induce relaxation in the patient by activating the limbic system (via olfactory nerve cells) as well as stimulating the immune, circulatory or nervous system. Massage lotion can include diverse components (e.g., moisturizers, pain-reliever or anti-inflammatory ingredients) which are absorbed in the skin during the massage. Aromatic oils and massage lotions further increase stimulation by smoothing the skin of the patient.

Massage generator 104 can be coupled with a selected one of right motor 112R, left motor 112L, or with both, for receiving power for generating the massaging feature (e.g., for vibrating or tapping).

Massage generator 104 is detachably coupled with massager vehicle 100 and can be replaced by a different massage generator (e.g., shiatsu massage generator is replaced with a heat applying massage generator). Some examples of massage generators are shiatsu fingers (i.e., for applying shiatsu massage), pinching massage generator, spinning massage generator, rotating massage generator, and the like. Massage generator 104 is detachably coupled with massager vehicle 100 via a coupling mechanism such as a screw, a clamp, and the like.

Massage generator 104 can further be coupled with at least one of right wheels 108R and left wheels 108L for employing these wheels for applying a massaging feature to the patient (e.g., massage generator 104 applies aromatic oil to the body of the patient via right wheels 108R). It is noted that, massager vehicle 100 can include more than one massage generator 104 for generating different massaging features to the body of the patient (e.g., massager vehicle 100 can include a wooden finger for caressing the body of the patient, and a metal rod for applying small electrical currents to the body of the patient).

Massager vehicle 100 can further include a communication interface, wired (e.g., USB, FireWire) or wireless (e.g., Bluetooth, zigbee, WiFi, Wimax or proprietary) coupled with controller 106. The communication interface enables other devices to communicate with massager vehicle 100. For example, a second massager vehicle (not shown) may be employed, communicating with massager vehicle 100 for coordinating massaging operations. Another example is an external controller (not shown) coordinating the massaging operations and movement of massager vehicle (e.g., a computer, a computer coupled with a camera which monitors the movement of massager vehicle 100, and the like). Further alternatively, massager vehicle 100 further includes a communication interface for receiving instructions from a human operator (e.g., the patient or a human massager—human interface). The communication interface can be a remote control, a voice activated control interface (i.e., for receiving oral commands), and the like.

Massager vehicle 100 can further include a music player (e.g., a radio tuner, a compact-disc player or a flash memory based player) and a speaker. The music player can be internal or an external music player docked on massager vehicle 100. The music player plays music during the massage for increasing the effects of the massage as well as the relaxing and enjoyment of the patient. Some examples of relaxing sounds are the sound of a gentle waterfall, the humming of birds, and soft songs. The music can either be coordinated with the massaging operation routine or independent there-from. The patient can choose her favorite sounds and music.

FIGS. 1B and 1C show isometric illustrative views of massager vehicle 100, from a bottom view perspective and from a top view perspective, respectively. However, it is noted, that the illustrative shape of the massager vehicle 100 in FIGS. 1B and 1C is brought as an exemplary shape, and the shape of a massager vehicle according to the disclosed technique is not limited to this shape by any way.

With reference to FIG. 1D, massager vehicle 100 travels on the back of a patient 122. Patient 122 is wearing a boundary marker 124 on the waistline thereof (e.g., a towel). In the example set forth in FIGS. 1D and 1E, boundary sensor 120 is an optical sensor for detecting boundary marker 124. In the example set forth in FIG. 1D massager vehicle 100 is traveling on the shoulder blades of patient 122. With reference to FIG. 1E, massager vehicle 100 travels on the back of a patient 122. In the example set forth in FIG. 1E massager vehicle 100 is traveling on the right lower back of patient 122. Massager vehicle massages patient 122 while traveling thereon.

Reference is now made to FIGS. 2A, 2B and 2C. FIG. 2A is a schematic illustration of a side view of a massager vehicle, generally referenced 150, having legs, constructed and operative in accordance with another embodiment of the disclosed technique. FIG. 2B is a front view of the massager vehicle of FIG. 2A. FIG. 2C is a schematic illustration of the massager vehicle of FIG. 2A, having a different leg configuration.

With reference to FIG. 2A, massager vehicle 150 includes a chassis 152 and a plurality of legs 154. Legs 154 are coupled with chassis 152. Each of legs 154 includes a rotating wheel 156, a rotation pin 158, a limb 160, and a static pin 162. Limb 160 includes a groove 164 at the top proximal end thereof. Rotating wheel 156 is coupled with a motor (e.g., left motor 112L of FIG. 1A) via a transmission gear (e.g., left transmission gear 110L of FIG. 1A), and with limb 160 via rotating pin 158. Static pin 162 extends from chassis 152 through groove 164.

The motor provides circular motion to rotating wheel 156. Rotating pin 158 moves along the circumference of rotating wheel 156, with limb 160 attached thereto. Static pin 162 extends through groove 164 such that static pin 162 slides up and down in groove 164, while limb 160 makes a crank like motion. The movement of leg 154 is determined by the movement of pin 162 within groove 164. In the example set forth in FIG. 2A, leg 154 on the right side of FIG. 2A is at the lowest possible position thereof, when pin 162 is at the top most position inside groove 164 (i.e., the bottom distal end of limb 160 is at the lowest possible position thereof). Leg 154 on the left side of FIG. 2A is in mid-height.

Legs 154 enable massager vehicle 150 to move across the body of the patient. Each of legs 154 applies pressure to the body of the patient while treading thereon. Alternatively, each pair of legs 154 (i.e., a leg 154 on the left lateral side of massager vehicle 150 and a leg 154 on the right lateral side, opposite the left leg) can nip the body of the patient by coordinately treading thereon. Further alternatively, each of legs 154 can caress the body of the patient, rotate in order to stimulate the body of the patient, vibrate (i.e., via vibrator 118 of FIG. 1A or via a different vibrator), squeeze, pinch, tickle, apply liquid, apply heat, apply cold, apply electric current, apply magnetic fields, apply shiatsu massage, apply acupuncture, and the like.

It is noted that, massager vehicle 150 includes at least three legs 154 for maintaining stability. In the example set forth in FIG. 2A, massager vehicle 150 includes two left legs (i.e., front and back left legs) and two right legs (i.e., front and back right legs) for a total of four legs. It is further noted that, the movement of each of legs 154 can be coordinated (i.e., each of legs 154 is at the same respective position of rotating pin 158) for increasing the negotiability of massager vehicle 150. In this manner, massager vehicle 150 operates similar to an all wheel drive vehicle.

With reference to FIG. 2B, massager vehicle 150 further includes static legs 166 extending downward from chassis 152 (e.g., four static legs located at each of the four corners of the bottom surface of chassis 152). When either one of legs 154 is suspended in the air (i.e., at a heightened position, not touching the body of the patient), massager vehicle 150 leans on static leg 166 nearest to the suspended one of legs 154, in order to prevent vehicle 150 from turning over. It is noted that, each of legs 154 is positioned at an inwards inclination. In other words, each of the legs is treading in a combined downward and inward direction. The inward inclination of the legs pinches the skin of the patient for increasing the stimulation thereof.

With reference to FIG. 2C, massager vehicle 150 includes four legs 174. Each of legs 174 includes a rotating wheel 170, a rotating pin 172, a limb 174, a support pin 176, a support limb 178, and a chassis pin 180. Rotating wheel 170, rotating pin 172 and limb 174 are substantially similar to rotating wheel 156, rotating pin 158 and limb 160 of FIG. 2A respectively. Support pin 176 rotatably couples limb 160 with support limb 170. Chassis pin 172 rotatably couples support limb 160 with chassis 152. Rotating pin 172 moves along the circumference of rotating wheel 170. The upper end of limb 174 moves with rotating pin 172. Support limb 178 maintains limb 174 moving up and down with the rotation of rotating wheel 170. Leg 168 on the right side of FIG. 2C is at its most heightened position (i.e., rotating pin 172 and the upper end of limb 174 are at the most heightened position thereof). Leg 168 on the left side of FIG. 2C is at mid-height position (i.e., rotating pin 172 and the upper end of limb 174 are at mid-height position).

Reference is now made to FIGS. 3A and 3B. FIG. 3A is a schematic illustration of a massager vehicle, generally referenced 200, traveling on the body of a patient at a roll inclination, constructed and operative in accordance with a further embodiment of the disclosed technique. FIG. 3B is a schematic illustration of the massager vehicle of FIG. 3A, traveling on the body of the patient at a pitch inclination. With reference to FIG. 3A, massager vehicle 200 includes chassis 202, right wheels 204R and left wheels 204L. Chassis 202 is coupled with right wheels 204R and left wheels 204L. Massager vehicle 200 is positioned on the left side of the back of a patient 206. Massager vehicle 200 is at a roll inclination of an angle α. A roll tilt sensor (not shown—e.g., roll tilt sensor 114 of FIG. 1A) determines whether angle α is unstable for massager vehicle 200 and whether massager vehicle 200 should change its course accordingly in order to position itself at a smaller, more stable, roll angle. For example, a roll angle greater than 20° may be considered unstable for massager vehicle 200 to travel on. The unstable roll angle α is determined according to massager vehicle 200 configuration and properties, such as center of mass, wheelbase, and the like.

With reference to FIG. 3B, massager vehicle 200 is positioned on the shoulder blades of patient 206. Massager vehicle 200 is at a pitch inclination of an angle β. A pitch tilt sensor (not shown—e.g., pitch tilt sensor 116 of FIG. 1A) determines whether angle β is unstable for massager vehicle 200 and whether massager vehicle 200 should change its course accordingly in order to position itself at a smaller pitch angle. For example, a tilt angle greater than 20° may be considered unstable for massager vehicle 200 to travel on. The unstable pitch angle β is determined according to massager vehicle 200 configuration and properties, such as center of mass, wheelbase, and the like.

Reference is now made to FIGS. 4A, 4B, 4C and 4D. FIG. 4A is a schematic illustration of a gravity fan tilt sensor, generally referenced 250, constructed and operative in accordance with another embodiment of the disclosed technique. FIG. 4B is a schematic illustration of the gravity fan tilt sensor of FIG. 4A in which the light barrier is divided into a plurality of barrier sectors. FIG. 4C is a schematic illustration of a top view of a groove and ball tilt sensor, generally referenced 270, constructed and operative in accordance with a further embodiment of the disclosed technique. FIG. 4D is a schematic illustration of a side view of the groove and ball tilt sensor of FIG. 4C.

With reference to FIG. 4A, gravity fan tilt sensor 250 includes light barrier 256, a right light sensor 254R and a left light sensor 254L. Light barrier 256 is coupled with an axis 252 such that light barrier 256 can swing around axis 252 in the direction of arrow 258. Tilt sensor 250 is a gravity based inclinometer. Gravity fan tilt sensor 250 determines when a massager vehicle (e.g., massager vehicle 100 of FIG. 1A) is positioned at an inclination exceeding a predetermined angle. When axis 252 is going from the front of the massager vehicle to the back thereof, tilt sensor 250 operates as a roll tilt sensor. When axis 252 is going from one side of the massager vehicle to the other side thereof, angle sensor 250 operates as a pitch tilt sensor.

Each of right light sensor 254R and left light sensor 254L includes a light source positioned confronting the light sensor. The light source illuminates the light sensor. When light barrier 256 swings in front of the light source and blocks the light sensor, the light sensor sends a signal to the controller which maneuvers the massager vehicle out of the corresponding inclination.

Light barrier 256 is formed at a shape of a triangle. Light barrier 256 blocks at least a portion of a light beam going there-through. Light barrier 256 is pulled down by gravity such that the base thereof is always perpendicular to the direction of the force of gravity. When the massager vehicle is positioned at an inclination, gravity pulls light barrier 256 such that it swings to one side until the base thereof is perpendicular to the direction of gravity. When the inclination of the massager vehicle exceeds a predetermined angle, light barrier 256 blocks either right light sensor 254R or left light sensor 254L, depending on the inclination of the massager vehicle. A controller of the massager vehicle (not shown—e.g., controller 106 of FIG. 1A) receives a signal from angle sensor 250 relating to information about the blocked light sensor. The controller can change the course of the massager vehicle in order to decrease the inclination thereof and allow light barrier 256 to swing towards the middle of angle sensor 250 and unblock the blocked light sensor.

With reference to FIG. 4B, light barrier 256 includes three types of light barrier sectors, a center sector 260C, a mid sector 260B and an edge sector 260A. The light transmission properties of each of the three types of light barrier sectors are different. According to the light received at each of the right light sensor 254R and left light sensor 254L, gravity fan tilt sensor 250 determines the range of the inclination angle of the massager vehicle. For example, when the massager vehicle is at a first inclination angle, light barrier 256 swings to the right, such that light barrier mid sector 260B is in front of right light sensor 254R. Light sensor 254R receives light corresponding to the light transmission properties of light barrier mid sector 260B and determines the inclination angle is at a predetermined range corresponding to the sector size of light barrier mid sector 260B. It is noted that, angle sensor 250 can include any number of light barrier sectors. The more light barrier sectors, the more accurate the determination of the inclination angle.

With reference to FIG. 4C, groove and ball tilt sensor 270 includes a groove 272, a ball 274, a left touch sensor 276L and a right touch sensor 276R. Ball 274 is positioned within groove 272 such that it can move only in lateral direction (i.e., either to the left or to the right). Groove 272 is V-shaped and the center thereof is at a downward inclination from each of the ends (i.e., and from each of left sensors 276L and right sensor 276R). Groove 272, ball 274, left sensor 276L and right sensor 276R are all made of conductive materials. When massager vehicle 100 (FIG. 1A) is at an inclination ball 274 slides down groove 272 and touches a respective one of left sensor 276L and right sensor 276R. When ball 274 touches a selected one of left sensor 276L and right sensor 276R, ball 274 closes a circuit and activates tilt sensor 270. Alternatively, each of left sensor 276L and right sensor 276R are pressure sensors, thus eliminating the need for groove 272 and ball 274 to be conductive. With reference to FIG. 4D, the inclination of groove 272 is δ. In order for ball 274 to touch either one of left sensor 276L and right sensor 276R the angle of inclination of massager vehicle 100 has to exceed δ.

In case the massager vehicle includes a vibrator installed thereon (e.g., vibrator 118 of FIG. 1A), each of gravity fan tilt sensor 250 and groove and ball tilt sensor 270 are constructed such that the vibrations of the vibrator will have a minimal effect on the readings of these sensors. The respective resonant frequency of each of sensors 250 and 270 is vastly different than the vibrations frequency of the vibrator and is at least not a multiple of the vibrations frequency of the vibrator, for damping the affect of the vibrations.

Reference is now made to FIG. 5, which is a schematic illustration of a massager vehicle, generally referenced 300, including a massage generator, constructed and operative in accordance with another embodiment of the disclosed technique. Massager vehicle 300 includes a right spring 304R, a left spring 304L and a massaging tool 306, all of which form a massage generator 310. Massager vehicle 300 further includes a chassis 302 and wheels 308. Massage generator 310 is coupled with the bottom of a chassis 302 of massager vehicle 300 such that massage generator 310 touches the body of a patient (not shown), massager vehicle 300 is traveling thereupon. Massager vehicle 300 is traveling at the direction of either of wheels 308.

Massaging tool 306 is V-shaped. Massaging tool 306 caresses the body of the patient while massager vehicle 300 travels thereupon. The form of massaging tool 306 prevents massaging tool 306 from stabbing the patient, or from being stuck at an obstacle (e.g., a button on the shirt of the patient) and stopping massager vehicle 300. Right spring 304R and left spring 304L help to prevent massaging tool 306 from stabbing the patient or from getting stuck at an obstacle, and stopping massager vehicle 300, by stretching and contracting when massaging tool 306 exerts a force thereon, when touching an obstacle. In this manner, massaging tool 306 may pass over an obstacle when springs 304L and 304R stretch or contract, accordingly. Alternatively, massaging tool 306 is U-shaped. Further alternatively, massaging tool 306 can be any shape which connects both right spring 304R and left spring 304L and having substantially no protruding parts.

Massaging tool 306 can be made of various materials and at various textures according to the preference of the patient. Massage generator 310 can be decoupled from chassis 302. Massage generator 310 can be replaced by a different massage generator. It is noted, that more than a single massage generator can be simultaneously coupled with chassis 302.

It is noted, that springs 304L and 304R can be positioned within chassis 302 such that massaging tool 306 is the only element of massage generator 310 protruding from chassis 302 for preventing the hair (i.e., the hair, the skin, and the like) of the patient from getting caught in either of springs 304L and 304R. Alternatively, springs 304L and 304R are covered by a shielding envelopment (e.g., a plastic cylinder enveloping each of springs 304L and 304R).

Reference is now made to FIG. 6, which is a schematic illustration of a massager vehicle, generally referenced 330, including a boundary sensor, constructed and operative in accordance with a further embodiment of the disclosed technique. Massager vehicle 330 includes a chassis 332, an upper sensing cover 334, a couple of touch sensors 336, and wheels 338. Chassis 332 is coupled with wheels 338. One of touch sensors 336 is coupled at the front side and another one of touch sensors 336 at the back side of chassis 332. Upper sensing cover 334 is mounted on chassis 332 such that it slides along chassis 332 until coming to a stop either on the front side or on the back side of chassis 332 (i.e., pushing one of touch sensors 336 while stopping). When upper sensing cover 334 collides with an obstacle it stops moving, while chassis 332 keeps moving at the current direction and upper sensing cover touches one of touch sensors 336. Touched touch sensor 336 sends a signal to a controller (not shown—e.g., controller 106 of FIG. 1A). Subsequently, the controller may reverse the direction of motion of vehicle 330, as it is indicated that vehicle 330 has hit a physical obstacle.

Reference is now made to FIG. 7, which is a schematic illustration of massager vehicle, generally referenced 360, including a plurality of massage generators, constructed and operative in accordance with a another embodiment of the disclosed technique. Massager vehicle 360 includes a chassis 362, a first massage generator coupling screw 364A, a second massage generator coupling screw 364B, a pinching massage generator 366, and wheels 372.

Chassis 362 is coupled with wheels 372, first massage generator coupling screw 364A and second massage generator coupling screw 364B. Pinching massage generator 366 includes a base 370 and two pinching arms 368. Base 370 of pinching massage generator 366 is coupled with chassis 362 via second massage generator coupling screw 364B (depicted as dotted since is enveloped by base 370). Pinching massage generator 366 is a massage generator directed at stimulating the skin of the patient by pinching. Pinching arms 368 can open and close for pinching the skin of the patient while massager vehicle 360 drives thereupon. Pinching arms 368 are coupled with a motor (e.g., left motor 112L of FIG. 1A) for generating the pinching motion.

Pinching massage generator 366 is detachably coupled with second massage generator coupling screw 364B, such that pinching massage generator can be replaced by any other massage generator (e.g., heat or cold applying massage generator, caresser massage generator and lotion applying massage generator). A user of massager vehicle 360 (i.e., either a patient or a care taking operator, such as a massagist) can connect a plurality of different massage generators to massager vehicle 360 for enhancing the stimulation thereof. It is noted, that massager vehicle 360 can include any number of massage generator coupling screws and thus any number of massage generators. Alternatively, at least one of first massage generator coupling screw 364A and second massage generator coupling screw 364B are replaced by a different coupling device such as a clamp and the like.

Reference is now made to FIG. 8, which is a schematic illustration of a massager vehicle, generally referenced 390, including a massage generator, constructed and operative in accordance with a further embodiment of the disclosed technique. Massager vehicle 420 includes a chassis 392, four wheels 394, a massage generator axle 396, a couple of massage generator arms 398, and a plurality of massage generator weights 400. Massage generator axle 396, massage generator arms 398 and massage generator weights 400 constitute together a massage generator (not referenced).

Chassis 392 is coupled with wheels 394. Massage generator axle 396 extends vertically from the top surface of chassis 392. Massage generator axle 396 is further coupled with a motor (not shown—either the motor which generates the locomotion of massager vehicle 390 or a motor specific for the massage generator). Massage generator arms 398 extend horizontally from massage generator axle 396. Each of massage generator weights 400 is coupled at the end, opposite of massage generator axle 396, of each of massage generator arms 398.

The motor rotates massage generator axle 396 in a clock wise direction, a counter clockwise direction, or in an alternately changing direction (alternating between clockwise rotations, counter clockwise rotations, and no rotations—static position). Massage generator axle 396 rotates massage generator arms 398. Massage generator arms 398 are flexible arms extending beyond chassis 392. Each of massage generator arms 398 ends with a respective one of massage generator weights 400. Each of massage generator weights 400 weight down its respective massage generator arm 398 and contacts the skin of the patient. The massage generator (i.e., axle 396, arms 398 and weights 400) extends beyond chassis 392 and massages portions of the skin of the patient massager vehicle 390 does not reach.

The number of massage generator arms 398, the length and flexibility of each of arms 398, the shape, texture, size and weight of each of massage generator weights 400 is predetermined, according to the desired massaging feature and the preferences of the user (i.e., either the patient or the care taking operator). For example, the massage generator includes three arms 398, each having a length double the length of massager vehicle 390. Each of arms 398 ends with a spherical metal weight 400 weighting 350 grams and having a smooth texture. Axle 396 rotates in a clock wise direction at a frequency of two rotations per minute.

Another example is a massage generator including four arms 398 which are rigid and not flexible. The length of each arm 398 is triple the length of massager vehicle 392. Each arm 398 ends with a feather, caressing the skin of the patient. Axle 396 does not rotate such that the position of each of arms 398 is constant. Yet another example is a massage generator including a single arm 398 ending with a metal rod weight 400, weighing 1 kilogram. The length of arm 398 is 20 centimeters. Arm 398 is highly flexible such that metal rod weight 400 can reach and apply pressure to portions of the skin of the patient which are at a high inclination and therefore unreachable for massager vehicle 390 (e.g., the side of the ribs of the patient).

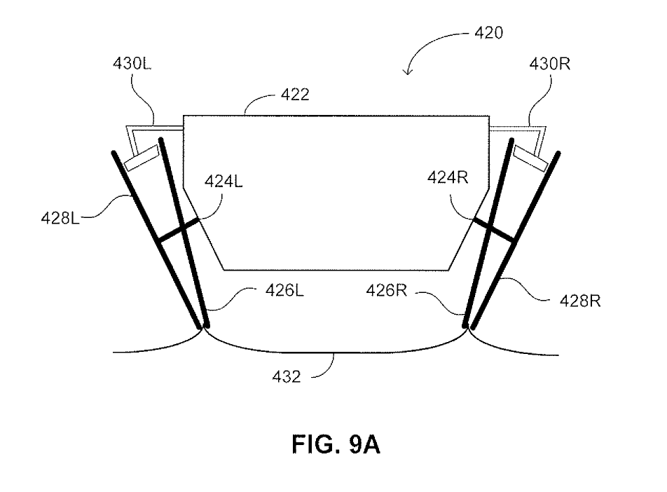

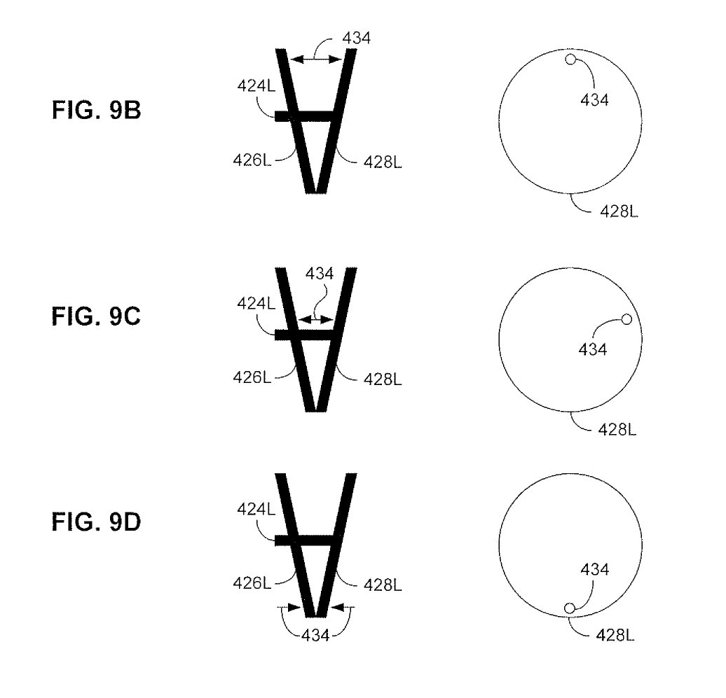

Reference is now made to FIGS. 9A, 9B, 9C, and 9D, which are schematic illustrations of a massager vehicle, generally referenced 420, including a plurality of pinching double wheels for climbing the skin and clothes of the patient, constructed and operative in accordance with another embodiment of the disclosed technique. Massager vehicle 420 includes a chassis 422, a couple of left wheel axles 424L, a couple of right wheel axles 424R, a couple of left inner wheels 426L, a couple of right inner wheels 426R, a couple of left outer wheels 428L, a couple of right outer wheels 428R, a couple of left wheels separators 430L, and a couple of right wheels separators 430R. It is noted that, massager vehicle 420 is depicted from a front view, such that only the front wheels are depicted in FIG. 9.

Left wheels axles 424L, right wheel axles 424R, left wheels separators 430L and right wheels separators 430R extend from chassis 422. Each one of left wheels axles 424L supports and rotates a respective one of left inner wheel 426L and a respective one of left outer wheel 428L. Each one of right wheels axles 424R supports and rotates a respective one of right inner wheel 426R and a respective one of right outer wheel 428R.

Each one of left wheels separators 430L separates the top ends of its respective left inner wheel 426L and left outer wheel 428L. In this manner the bottom ends of the respective left inner wheel 426L and left outer wheel 428L are forced towards each other. Each one of right wheels separators 430R separates the top ends of its respective right inner wheel 426R and right outer wheel 428R. In this manner the bottom ends of the respective right inner wheel 426R and right outer wheel 428R are forced towards each other. Each wheel axle along with its respective inner wheel, outer wheel, and wheel separator constitutes a double wheel. For example, left wheel axle 424L, left inner wheel 426L, left outer wheel 428L, and left wheel separator 430L, constitute a left double wheel (not referenced).

Each of the double wheels of massager vehicle 420 produces a pinch as it rotates. The pinching maneuver of each of the double wheels is better understood by observing the distance between a pair of parallel dots, one on the inner wheel and the other on the outer wheel. The pair of dots defines an imaginary axis connecting the dots. With reference to FIGS. 9B, 9C, and 9D, an exemplary one the double wheels includes a left axle 424L, a left inner wheel 426L, a left outer wheel 428L, and an imaginary axis 434. In case the parallel dots (not shown) defining imaginary axis 434 are positioned on the top end of the double wheel (FIG. 9B), the length of imaginary axis 434 is D₁. In case the double wheel completed a quarter of a rotation in the clockwise direction, imaginary axis 434 is positioned approximately in the middle of the double wheel (i.e., at the right end of the double wheel—FIG. 9C) and the length of imaginary axis 434 is D₂. In case the double wheel has completed another quarter of a rotation in the clockwise direction, imaginary axis 434 is positioned on the bottom end of the double wheel (FIG. 9D) and the length of imaginary axis 434 is D₃. It is noted that D₁>D₂>D₃. Massager vehicle 420 employs the pinching maneuver of each of the double wheels to cling to a clothing item (e.g., shirt) or to the skin of the patient. In this manner, massager vehicle 420 can climb up on the patient.

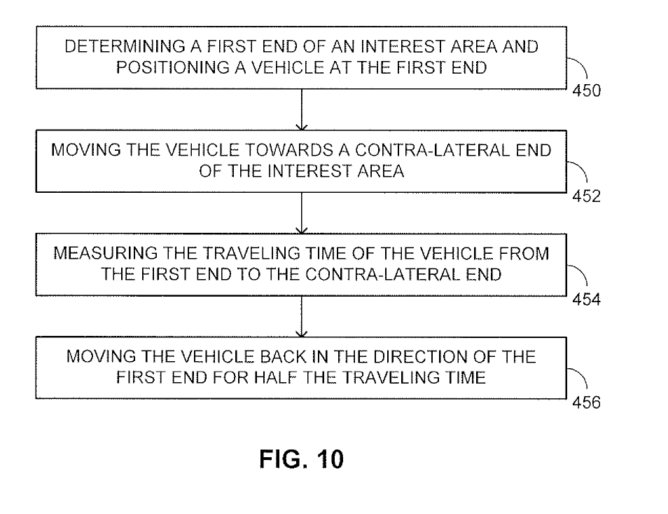

Reference is now made to FIG. 10, which is a schematic illustration of a method for positioning a vehicle at the center of an interest area, operative in accordance with a further embodiment of the disclosed technique. In procedure 450, a first end of the interest area is determined and the vehicle is positioned at the first end. With reference to FIG. 1A, massager vehicle 100 travels to a first direction until controller 106 determines massager vehicle reached an end of the patient (i.e., according to input form roll tilt sensor 114, pitch tilt sensor 116 and boundary sensor 120).

In procedure 452, the vehicle is moved towards a contra-lateral end of the interest area. With reference to FIG. 1A, massager vehicle 100 reverses direction of movement and travels towards the contra-lateral end of the body of the patient. In procedure 454, the traveling time of the vehicle from the first end to the contra-lateral end is measured. With reference to FIG. 1A, controller 106 measures the traveling time of massager vehicle 100 from the first end to the contra-lateral end.

In procedure 456, the vehicle is moved back in the direction of the first end for half the traveling time. With reference to FIG. 1A, controller 106 directs massager vehicle 100 to reverse the direction of movement and travel towards the first end for half the traveling time (i.e., the traveling time from the first end to the contra-lateral end). When massager vehicle travels for half the traveling time, massager vehicle 100 is positioned approximately at the center between the first end of the body of the patient and the contra-lateral end. If massager vehicle determines the center of the body of the patient at two perpendicular directions, massager vehicle determines the center of the body of the patient. Alternatively, instead of determining travel time, it is possible to determine travel distance and traveling back for half the distance.

It will be appreciated by persons skilled in the art that the disclosed technique is not limited to what has been particularly shown and described hereinabove. Rather the scope of the disclosed technique is defined only by the claims, which follow.

1. Massager vehicle for autonomously traveling on the body of a patient, the massager vehicle massaging the body of the patient, the massager vehicle comprising:
a vehicle chassis;
at least one motor;
at least three wheels coupled with said chassis and with said at least one motor, at least one of said wheels being positioned at a first side of said chassis, and at least one of another one of said wheels being positioned at a second side of said chassis, opposite to said first side;
a roll tilt sensor, for determining a roll angle of said vehicle;
a pitch tilt sensor, for determining a pitch angle of said vehicle;
a boundary sensor, for determining when said massager vehicle is approaching a boundary, beyond which said massager vehicle may not travel;
a controller for controlling the motion of said vehicle, said controller being coupled with said motor, said roll tilt sensor, said pitch tilt sensor and with said boundary sensor, said controller receiving information from said roll tilt sensor, said pitch tilt sensor and from said boundary sensor, said controller instructing said motor to change the direction of travel of said vehicle according to said received information.

2. The massager vehicle of claim 1, further comprising a sliding cover, mounted on said chassis and sliding along the surface of said chassis,
wherein said boundary sensor includes a plurality of touch sensors, said touch sensors being coupled with said chassis at the outer perimeter surface of said chassis, between said chassis and said cover, such that when said cover comes in contact with an external obstacle, said cover slides along said chassis until touching at least on of said touch sensors, indicating that said vehicle has hit a physical obstacle.

3. The massager vehicle of claim 1, wherein said boundary sensor includes a touch sensor, coupled with said chassis, and extending toward the surface on which said massager vehicle travels, for sensing a physical obstacle touching with said touch sensor.

4. The massager vehicle of claim 1, wherein said boundary sensor includes an optical sensor for sensing a physical obstacle or designated marking on the body of said patient.

5. The massager vehicle of claim 1, wherein said boundary sensor includes a Radio Detection and Ranging (RADAR) sensor operating at Micro-Wave frequencies.

6. The massager vehicle of claim 1, wherein said boundary sensor includes a Sound Navigation and Ranging (SONAR) sensor.

7. The massager vehicle of claim 1, wherein said boundary sensor includes a magnetic sensor for sensing a designated marking on the body of said patient.

8. The massager vehicle of claim 1, wherein said boundary sensor includes a processing unit for determining a physical boundary by calculation of the route in which said vehicle travels.

9. The massager vehicle of claim 8, wherein said processing unit calculates said route according to the time said vehicle traveled in one direction, said controller instructing said motor to stop after said vehicle has traveled a predetermined amount of time in said direction.

10. The massager vehicle of claim 1, further comprising a massage generator, externally coupled with said chassis such that said massage generator touches the surface on which said massager vehicle travels, for massaging the body of said patient while said massager vehicle travels thereon.

11. The massager vehicle of claim 10, wherein said massage generator includes a massaging tool, coupled with said chassis through a plurality of springs, said massaging tool being in contact with the surface on which said massager vehicle travels, wherein when said massaging tool hits a physical obstacle, said springs stretch and contract according to a force exerted by said massaging tool, for allowing said massaging tool to pass over said obstacle.

12. The massager vehicle of claim 10, wherein said massage generator performs a massaging feature, said massaging feature includes at least one feature selected from the list consisting of:
caressing said body of said patient;
applying a liquid to said body of said patient;
heating said body of said patient;
cooling said body of said patient;
vibrating said body of said patient;
Applying tapping to said body of said patient;
Applying squeeze to said body of said patient;
Applying pinching to said body of said patient;
Applying shiatsu massage to said body of said patient;
Applying acupuncturing to said body of said patient;
Applying tickling to said body of said patient;
Applying phototherapy to said body of said patient;
applying electrical current to said body of said patient; and
applying magnetic field to said body of said patient.

13. The massager vehicle of claim 10, wherein said massage generator is detachably coupled with said massager vehicle, such that said massage generator can be replaced by a different massage generator.

14. The massager vehicle of claim 10, wherein said massage generator includes:
a massage generator axis coupled with said vehicle chassis;
at least one massage generator arms coupled with said massage generator axle, said massage generator arms extend beyond said vehicle chassis; and
at least one massage generator weights, each one of said massage generator weights is coupled with the end, opposite of said massage generator axle, of a respective one of said massage generator arms, each one of said massage generator weights weight down said respective one of said massage generator arms and contacts the body of said patient.

15. The massager vehicle of claim 1, further comprising a vibrator, coupled with said controller, for vibrating said massager vehicle.

16. The massager vehicle of claim 15, wherein each of said roll tilt sensor, pitch tilt sensor, and boundary sensor, being constructed such that the resonance frequency thereof is different than the vibrations frequency of said vibrator.

17. The massager vehicle of claim 15, wherein each of said roll tilt sensor, pitch tilt sensor, and boundary sensor, being constructed such that the resonance frequency thereof is not a multiple of the vibrations frequency of said vibrator.

18. The massager vehicle of claim 1, further comprising a plurality of transmission gears, each of said gears being coupled between said motor and a respective one of said wheels, for transmitting motion from said motor to said wheels.

19. The massager vehicle of claim 18, wherein said transmission gears are constructed of an elastic material, for silencing the noise of said motor.

20. The massager vehicle of claim 1, further comprising a communication interface coupled with said controller for externally coordinating the massaging operations and the movements of said massager vehicle.

21. The massager vehicle of claim 20, wherein said communication interface is selected from the list consisting of:
human interface;
USB;
FireWire;
Bluetooth;
Zigbee;
WiFi; and
Wimax.

22. The massager vehicle of claim 1, wherein said controller determines the center of said body by operating said massager to travel to a first edge of said body of said patient and then to the contra-lateral edge of said body of said patient, measuring the traveling time from said first edge to said contra-lateral edge, and positioning said massager vehicle at the center of said body by operating said massager to travel to said first edge for a duration equal to half of said traveling time.

23. The massager vehicle of claim 1, wherein said controller determines the center of said body by operating said massager to travel to a first edge of said body of said patient and then to the contra-lateral edge of said body of said patient, measuring the distance from said first edge to said contra-lateral edge, and determining the center of said body at the half point of said distance.

24. The massager vehicle of claim 1, wherein at least one of said roll tilt sensor and said pitch tilt sensor is a selected from the list consisting of:
gravity fan tilt sensor;
liquid capacitive inclinometer;
piezoelectric inclinometer;
electrolytic inclinometer;
gas bubble in liquid inclinometer; and
groove and ball tilt sensor.

25. The massager vehicle of claim 1, wherein at least one of said wheels is a double wheel performing a pinching maneuver as it rotates.

26. Massager vehicle for autonomously traveling on the body of a patient, the massager vehicle massaging the body of the patient, the massager vehicle comprising:
a vehicle chassis;
at least one motor;
at plurality of legs coupled with said chassis and with said at least one motor;
a roll tilt sensor, for determining a roll angle of said vehicle;
a pitch tilt sensor, for determining a pitch angle of said vehicle;
a boundary sensor, for determining when said massager vehicle is approaching a boundary, beyond which said massager vehicle may not travel;
a controller for controlling the motion of said vehicle, said controller being coupled with said motor, said roll tilt sensor, said pitch tilt sensor and with said boundary sensor, said controller receiving information from said roll tilt sensor, said pitch tilt sensor and from said boundary sensor, said controller instructing said motor to change the direction of travel of said vehicle according to said received information.

27. The massager vehicle of claim 26, wherein said plurality of legs are massaging said portion of said body by performing one of the list consisting of:
applying pressure on said portion of said body;
nipping said portion of said body;
caressing said portion of said body;
vibrating on said portion of said body;
rotating said portion of said body;
applying a liquid to said portion of said body;
heating said portion of said body;
cooling said portion of said body;
tapping said body of said patient;
squeezing said body of said patient;
pinching said body of said patient;
applying shiatsu massage to said body of said patient;
Applying acupuncture to said body of said patient;
tickling said body of said patient;
applying phototherapy to said body of said patient;
applying electrical current to said portion of said body; and
applying magnetic field to the body of said patient.

28. The massager vehicle of claim 26, wherein each of said legs is positioned at an inwards inclination such that each of said legs treads in a combined downward and inward direction.

29. The massager vehicle of claim 26, further comprising a plurality of static legs, said plurality of static legs extending downward from said chassis, when either one of said legs is suspended in the air said massager vehicle leans on a selected one of said static leg in order to prevent said massager vehicle from turning over, wherein said selected one of said static legs is nearest to said suspended one of said legs.
